(19) United States
(12) Patent Application Publication
(10) Pub. No.: US 2025/0041851 A1
(43) Pub. Date: Feb. 6, 2025

(54) FLUID-MECHANICAL BLOOD COAGULATION TESTING

(71) Applicant: The Texas A&M University System, College Station, TX (US)

(72) Inventors: Hatice Ceylan Koydemir, College Station, TX (US); Weiming Xu, College Station, TX (US)

(21) Appl. No.: 18/793,514

(22) Filed: Aug. 2, 2024

Related U.S. Application Data
(60) Provisional application No. 63/517,289, filed on Aug. 2, 2023.

(51) Int. Cl. B01L 3/00; G06T 7/00

(52) U.S. Cl. CPC B01L 3/502715; G06T 7/0016; B01L 2200/025; B01L 2200/12; B01L 2300/041; B01L 2300/0627; B01L 2300/0887; B01L 2300/12; G06T 2207/10016; G06T 2207/30104; G06T 2207/30242

(57) ABSTRACT

Blood coagulation testing can be performed by measuring, based on video of a blood sample flowing in a microfluidic channel, the time it takes until flow stops due to clotting. In various embodiments, such measurements are enabled by a low-cost testing system that includes a microfluidic cartridge and uses a smartphone or similar device for video acquisition, in conjunction with a lighting module for illuminating the microfluidic channel and a 3D-printed platform for holding and positioning and orienting the cartridge, lighting module, and smartphone in fixed special relation to each other.

### CROSS-REFERENCE TO RELATED APPLICATION

This application claims priority to and the benefit of U.S. Provisional Patent Application No. 63/517,289, filed on Aug. 2, 2023, the contents of which are hereby incorporated herein by reference in their entirety.

### BACKGROUND

Cardiovascular diseases (CVDs) are heart and blood vessel disorders affecting hundreds of millions of people worldwide. Stroke, congenital heart disease, and heart rhythm disorders are the most common CVDs, and thrombotic events of such conditions are a global burden, accounting for 25% of deaths. In current clinical practice, blood-thinning medicines are recommended to slow and prevent the formation of blood clots in the vessels. They are usually prescribed for at least six months and up to the rest of the patient's life, depending on the level of the risk. Among the different options, warfarin is the most widely administered blood-thinning drug globally (with more than 20 million prescriptions in the US alone) due to its wide availability and low cost (˜$3 per month in the US). Warfarin is a vitamin K antagonist (VKA), that is, its mechanism of action is based on inhibiting the synthesis of vitamin-K-dependent clotting factors. Since these clotting factors interact with the contents of the food intake and over-the-counter pain relievers, the optimal warfarin dose can change over time. To avoid an increased risk of blood clots or bleeding, the warfarin dose is generally adjusted based on frequent coagulation testing. The standard test for measuring coagulation is the Prothrombin Time/International Normalized Ratio (PT/INR) blood test, which involves measuring the time it takes for a clot to form in a blood sample, called the “prothrombin time” (PT), and then calculating the INR based on the result of the PT test to provide for comparability of test results between different laboratories. For patients taking VKAs like warfarin, PT/INR testing is usually performed at least once a month, and sometimes as often as twice a week, requiring frequent hospital visits by the patient, as well as trained personnel to perform the test.

To overcome these disadvantages, a variety of fixed-dose anticoagulants such as dabigatran and apixaban, which are not affected by food intake, have been made available in the market in recent years. These anticoagulants are as effective as warfarin and do not require frequent blood tests. However, they are significantly more expensive (e.g., dabigatran and apixaban totaling ˜$300 per month, which is ˜100 times the cost of warfarin). Further, these fixed-dose anticoagulants are short-acting and therefore require careful dose management: missing a dose entails a greater risk of stroke than missing a dose of the slower-acting warfarin. Also, fixed-dose anticoagulants cannot be used safely by patients with severe kidney malfunction.

In recent years, commercial platforms for INR patient self-testing have become available in the market, especially in the United States, accommodating the use of warfarin or other VKAs while decreasing hospital visits, and as such increasing the quality of life for the patient. These platforms provide high sensitivity and accurate results. However, with device costs ranging from $600 to more than $3,000 and disposable test strips costing between $7 and $18 per test, often not covered by insurance, these platforms are not affordable for every patient, and in low-resource settings (e.g., in developing countries), they may be altogether inaccessible. Therefore, there is an unmet need for a more accessible, fully field-portable, and low-cost platform for INR testing.

### SUMMARY

Presented herein are systems and methods for fluid-mechanical blood coagulation testing involving recording a video of the flow of a blood sample (e.g., a sample of whole blood or blood plasma) through a microfluidic channel (also “microchannel” or simply “channel”) and then processing the video to determine the time it takes until fluid flow stops due to coagulation. The disclosed coagulation testing system may include a microfluidic cartridge defining the microchannel, a monitoring device for video recording, and a computational facility for video processing. The microchannel in the cartridge is configured to draw the sample into the channel via capillary forces, e.g., from a sample loading zone likewise defined in the cartridge. The monitoring device includes a lighting module for illuminating the microchannel and a camera for acquiring the video of the sample flowing through the channel, along with a platform or housing for holding the lighting module and camera in a fixed spatial relation to the cartridge. More specifically, the camera may be positioned and oriented relative to the cartridge to capture illumination that undergoes total internal reflection at a boundary surface of the microchannel. Filling of the microchannel with the sample increases the refractive index in the channel and thus the critical angle associated with the total internal reflection, causing a reduction in the intensity of the reflected light. This change in intensity can be used, when processing the video, to discriminate between filled and empty portions of the microchannel in each frame. For whole blood samples, the color difference between filled and empty portions can alternatively be used as a discriminator. In either case, the computational facility may execute a program to identify pixels corresponding to filled channel portions in each frame, determine the number of pixels in the filled portions, and detect based on comparisons between frames when that number no longer increases, indicating that the flow has stopped. The associated flow stopping time can then be computationally converted to PT/INR value.

Various embodiments described herein implement the above-described system and operating principles in a cost-effective manner. In some examples, the monitoring device utilizes a smartphone, tablet, or similar camera-equipped electronic device (hereinafter “smartphone-like device”) to record the video with its integrated camera. The smartphone-like device may also serve as the computational facility for processing the acquired video, or alternatively, utilize its network connection to transmit the recorded video to a separate computer for processing. The remaining system components can be provided at low cost. The cartridge may be a laminated structure including a plastic layer and a glass layer adhered to each other by an adhesive tape defining the microchannel. The platform or housing holding the smartphone-like device, lighting module, and microfluidic cartridge may be made from inexpensive materials (e.g., thermoplastics) by three-dimensional (3D) printing. In some embodiments, the platform consists of two parts: an open box including a tray for the microfluidic cartridge at the bottom, and a lid for holding the smartphone or tablet, e.g., oriented at an angle between 20° and 40° relative to the bottom tray. The lighting module may be implemented by one or more light-emitting-diode (LED) backlight modules mounted to an interior side wall (or walls) of the platform, optionally powered by the smartphone or tablet, which eliminates the need for a separate external power source. The box configuration of the platform may provide a controlled optical environment and facilitate uniform illumination of the microchannel, without the need for lenses or filters, which contributes to low device cost. The platform may be foldable, which allows for increased portability and reduced storage space. In addition, the platform can be easily modified to accommodate different smartphone-like devices of different form factors and camera locations, making it a versatile tool for various healthcare settings.

The foregoing summary is intended to introduce certain principles of fluid-mechanical coagulation testing in accordance herewith, as well as to provide examples of features and benefits provided in accordance with some (but not necessarily all) embodiments. The following description explains various embodiments more fully and in conjunction with the accompanying drawings.

### BRIEF DESCRIPTION OF THE DRAWINGS

FIG. 1 is a block diagram of a system for measuring blood coagulation, in accordance with various embodiments.

FIGS. 2A-2C illustrate an example microfluidic cartridge in accordance with one embodiment in top, perspective, and cross-sectional views, respectively.

FIGS. 3A-3E illustrate, in a series of perspective views, an example workflow for the assembly of the microfluidic cartridge of FIGS. 2A-2C, according to one embodiment.

FIGS. 4A and 4B illustrate, in perspective views, an example smartphone-based monitoring device according to one embodiment.

FIGS. 5A-5F are perspective views illustrating an example workflow for folding the 3D-printed platform of FIGS. 4A and 4B, according to one embodiment.

FIGS. 6 is a flowchart of an example workflow for measuring blood coagulation, in accordance with various embodiments.

FIGS. 7A-7H illustrate the workflow of an example video processing algorithm to determine the flow stopping time of a blood sample, in accordance with one embodiment.

FIGS. 8A-8C illustrate flow-stopping time measurements, in accordance with one embodiment, of control plasma samples and control blood samples at three different coagulation control levels.

FIGS. 9A-9C illustrate performance evaluations of INR estimation in accordance with one embodiment based on human whole blood samples with known INR values.

### DESCRIPTION

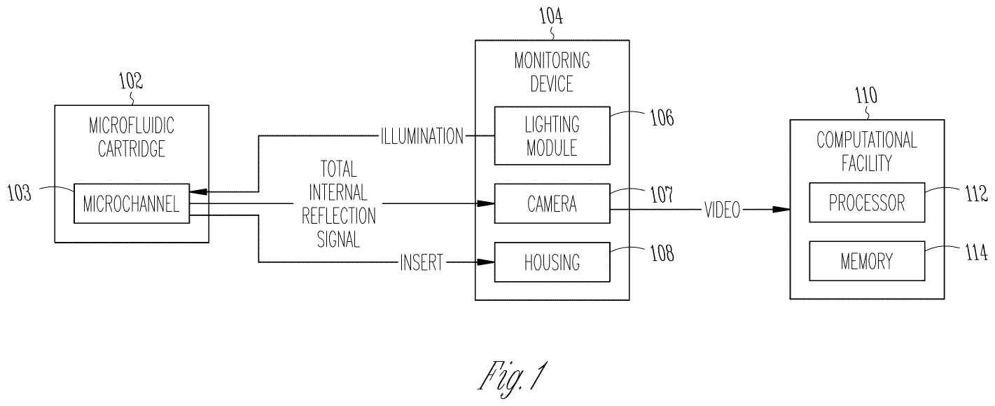

FIG. 1 is a block diagram illustrating functional components of a system 100 for measuring blood coagulation, in accordance with various embodiments. The system 100 includes a disposable microfluidic cartridge 102 defining a microchannel 103; a reusable monitoring device 104 including a lighting module 106 and camera 107 positioned within a housing or platform 108; and a computational facility 110 in communication with the monitoring device 104. In some embodiments, the integrated camera of a smartphone (or, more broadly, smartphone-like device) serves as the camera 107. In other embodiments, the camera 107 is provided by a standalone device such as a digital camera device or webcam, or is custom-constructed for the monitoring device 104 from an image sensor (e.g., a CCD or CMOS sensor) and optical components (such as lenses for imaging, and optionally filters and the like). The lighting module 106 includes, in some embodiments, one or more LED backlight modules, which are suitable for providing uniform illumination. However, other light sources, such as individual LEDs or LED arrays (not necessarily configured as a backlight module), fluorescent or incandescent light bulbs, and laser sources, may also in principle be used, e.g., in conjunction with optics components for diffusing or filtering the light. In general, both the lighting module 106 and the camera 107 may be fixedly installed components of the monitoring device 104, or may be provided by separate devices that are removed from the monitoring device 104 after use. For removable components, the housing 108 of the monitoring device 104 may provide mechanical guidances (stops, ledges, etc.) that facilitate placing the components reproducibly at a defined location.

In use, the microfluidic cartridge 102 is placed into the monitoring device 104 device at a defined location within the housing 108, either already loaded with a sample (e.g., a whole-blood or plasma sample) or to be loaded with the sample upon placement into the device 104. The monitoring device 104 is configured, via the relative positions and orientations of the cartridge 102, lighting module 106, and camera 107, to illuminate the microchannel 103 and capture video of a blood sample flowing into the microchannel 103 under capillary forces until coagulation stops the flow. In various embodiments, the video includes signal resulting from total internal reflection of light originating from the lighting module 106 at the surface of the microchannel 103; beneficially, this signal differs in intensity, and thus allows visually distinguishing, between filled and empty channel portions, regardless of whether the sample has a color (like whole blood) or is colorless (like plasma). For whole blood samples, the filled channel portions can, alternatively, be identified based on their red color.

The computational facility 110 receives and processes the video received from the monitoring device 104. In general, the computational facility 110 may be implemented by any suitable combination of computational hardware and software, e.g., including one or more general-purpose hardware processors 112 (e.g., central processing units (CPUs), optionally used in conjunction with one or more graphic processing units (GPUS)) executing software stored in computer memory 114, or one or more special-purpose hardware processors (such as digital signal processors (DSPs), field-programmable gate arrays (FPGAs), or hardwired electronic circuitry configured to implement a program for video processing). For example, the computational facility 110 may be desktop, laptop, or tablet personal computer, or a server computer to which the monitoring device 104 connects remotely via the internet. In embodiments using a smartphone or tablet to provide the camera 107, the smartphone or tablet may double as the computational facility 110.

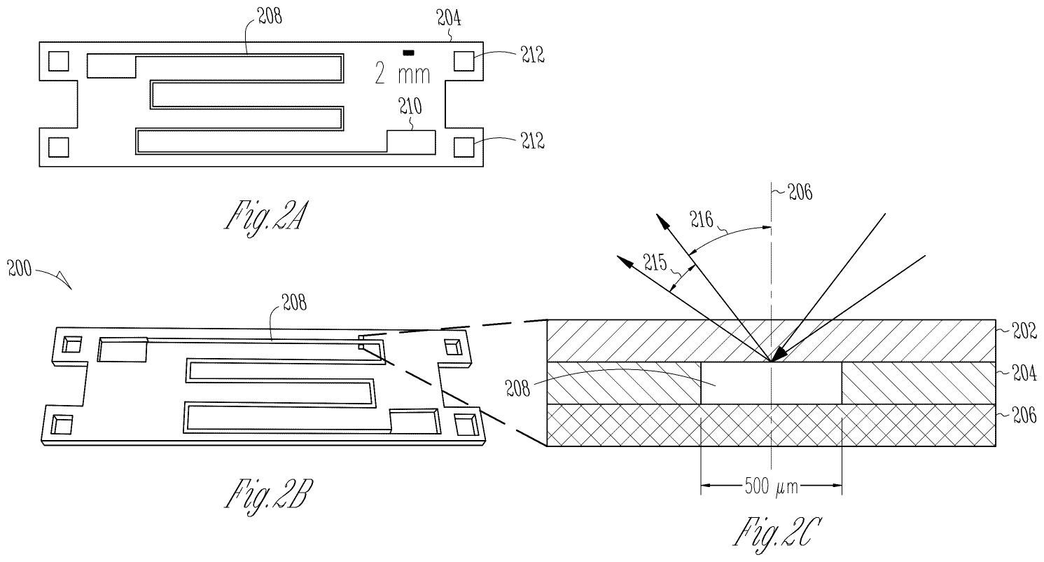

FIGS. 2A-2C illustrate an example microfluidic cartridge 200 (implementing cartridge 102 in FIG. 1) in accordance with one embodiment in a top and perspective views and a cross-sectional view through the microchannel, respectively. As can be seen in the cross-sectional view (FIG. 2C), the cartridge 200 is a laminated structure including or consisting of three carefully aligned layers: a transparent plastic layer 202 (e.g., of polyethylene terephthalate (PET) or acrylic), an adhesive tape layer (or simply “adhesive tape”) 204, and a glass layer (also “glass slide”) 206 (not drawn to scale). The adhesive tape layer 204 is patterned, as shown in FIG. 2A, to define a microchannel 208 (corresponding to microchannel 103 in FIG. 1) and associated sample loading zone(s) 210, and is located in between the plastic and glass layers 202, 206 to stick the three layers 202, 204, 206 together. In principle, the top and bottom layers of the laminated structure could be both glass or both plastic, but using a combination of plastic and glass provides a number of benefits. A plastic (e.g., PET) layer is generally cheaper and thinner than a glass slide, but its hydrophilicity is poor. Therefore, double plastic layers (with an intervening patterned adhesive tape layer) require a larger driving force for the solution to flow in the channel. While such larger driving forces may be achievable by reducing the cross-sectional dimensions of the microchannel to increase its capillarity, smaller dimensions entail a risk of clogging that might stop the sample flow prior to coagulation, corrupting results. On the other hand, double glass layers are too fragile, making cartridge fabrication and storage difficult. Combining plastic and glass layers takes advantage of the benefits of both materials while minimizing their drawbacks.

The cartridge may have lateral dimensions on the order of centimeters and a thickness on the order of millimeters. The microchannel generally has sub-millimeter cross-sectional dimensions (e.g., between 50 and 200 μm), and a length on the order of centimeters or decimeters. In one example, the cartridge 200 has a size of ˜2400 mm² (92 mm×26 mm), a PET layer height of 1 mm and a glass layer height of 1 mm for a total height of ˜2 mm, and the adhesive tape layer 204 used to assemble the glass slide 206 and PET layer 202 is 3M® double-sided adhesive tape (468MP, 3M®) with a thickness of 130 μm. The microchannel 208 may have a meandering layout (as shown), in one example with a total channel length of 238 mm, and a rectangular cross section with a channel width of 500 μm. A laser cutting machine (e.g., LS1613, BossLaser) may be used to cut the PET and adhesive tape layers 202, 204 into the desired shape with four alignment markers 212, as well as to cut the microchannel 208 into the adhesive tape layer 204. PET is easy to cut, and as such a suitable choice for the transparent plastic layer.

FIG. 2C also illustrates the operating principle of detecting fluid in the microchannel 208 based on a change in total internal reflection. The transparent plastic layer 202 has a higher refractive index than both air and the sample solution. Therefore, regardless of whether the microchannel 208 is filled or not, light that is incident on the interface between plastic layer 202 and microchannel 208 at an angle with respect to the surface normal 214 that exceeds the critical angle associated with the index contrast between the plastic layer and the microchannel is reflected at the interface. With the camera positioned and oriented to capture the light resulting from total internal reflection, the microchannel will appear bright in the video. Further, since the index contrast is lower if the microchannel is filled with sample solution, the associated critical angle 215 is greater than the critical angle 216 for the empty channel, and accordingly, less light is reflected as sample solution fills the channel. As a result, filled portions of the microchannel appear darker in the video, and can thus be distinguished from empty portions.

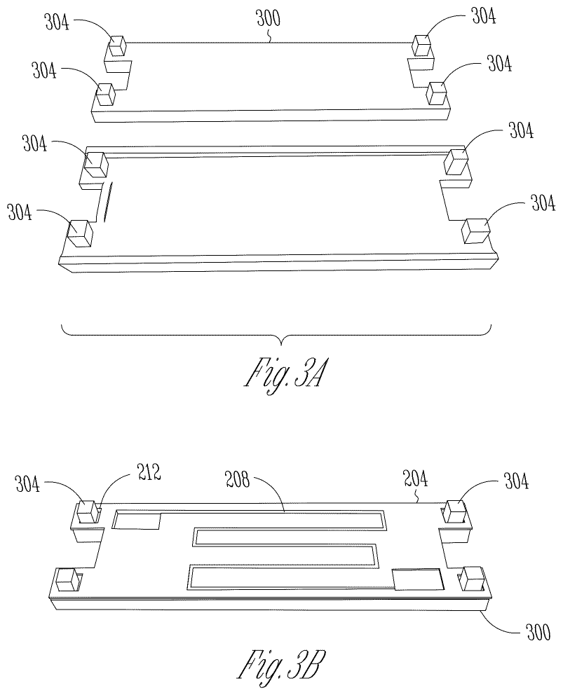

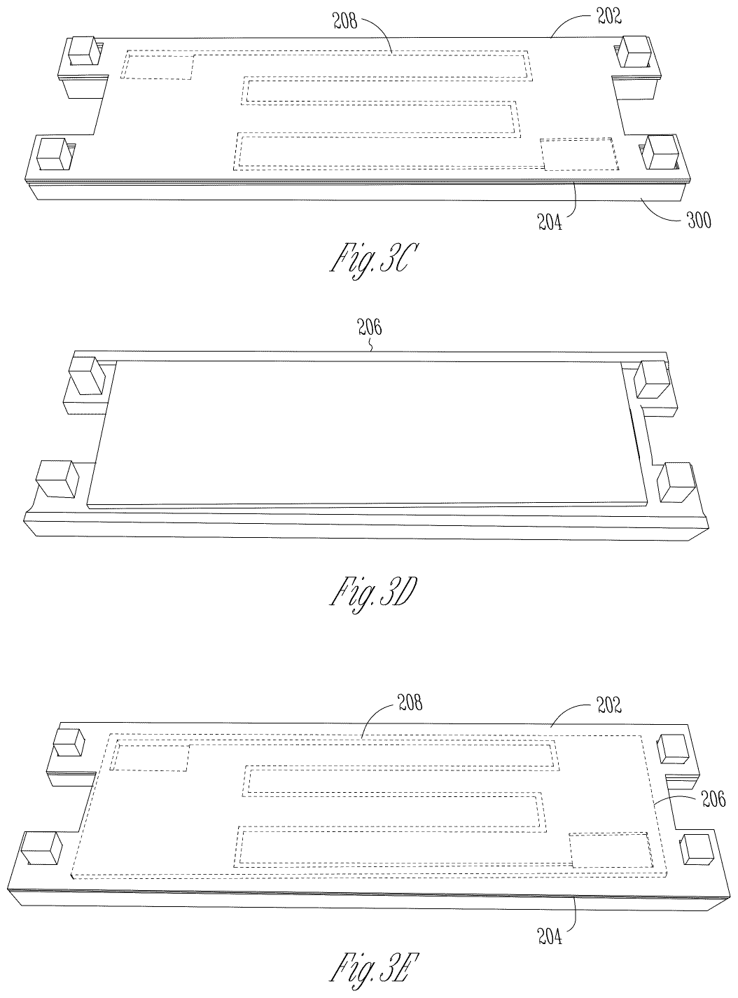

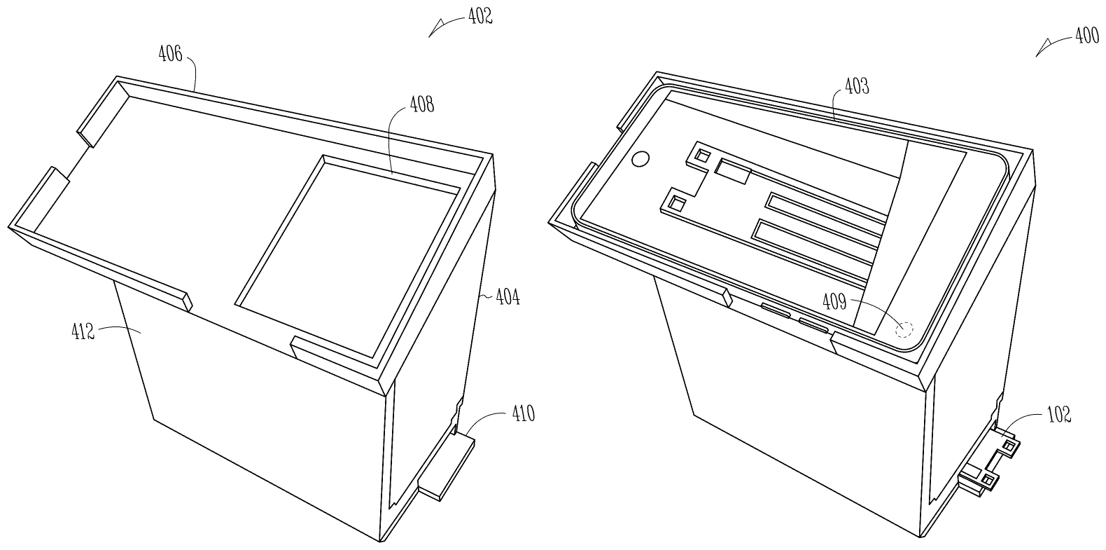

FIGS. 3A-3E illustrate, in a series of perspective views, an example workflow for the assembly of the microfluidic cartridge 200 of FIGS. 2A-2B according to one embodiment. The assembly uses attachment helpers 300, 302, shown in FIG. 3A, for the PET layer 202 and glass slide 206, respectively. These attachment helpers 300, 302 include protruding alignment stoppers 304 spaced and positioned to match the alignment markers 212 in the PET and glass layers 202, 206. The attachment helpers 300, 302 may be 3D-printed from polylactic acid (PLA) filament. The PET layer attachment helper 300 may be covered with an acrylic layer to provide a flat and smooth surface, which reduces the formation of bubbles between the PET layer 202 and the adhesive tape layer during the bonding of layers 202, 206 to each other.

To create the microchannel 208, the channel pattern is first cut into the adhesive tape 204 using the laser cutter, and then the adhesive tape 204 is installed and fixed onto the PET layer attachment helper 300, using the alignment stoppers and markers 304, 212, as shown in FIG. 3B. Next, the first protective cover film is removed from the adhesive tape 204, and the PET layer 202 is attached to the adhesive tape 204, as depicted in FIG. 3C. Once the PET-adhesive tape layer structure has been assembled, it is removed from the PET attachment helper 300. Next, a glass slide 206 is placed onto the glass slide attachment helper 302, using one of the alignment stoppers 304 to fix its position, as shown in FIG. 3D. The second protective cover film on the adhesive tape is then peeled off, and the assembled PET-adhesive tape layer is attached to the glass slide 206, as illustrated in FIG. 3E. After removing the assembled three-layer cartridge from the glass slide attachment helper 302, a squeegee may be used to remove any remaining bubbles around the microchannel 208. The use of a laser cutter and attachment helpers makes the fabrication process precise and efficient, while the use of an acrylic layer reduces the formation of bubbles during assembly.

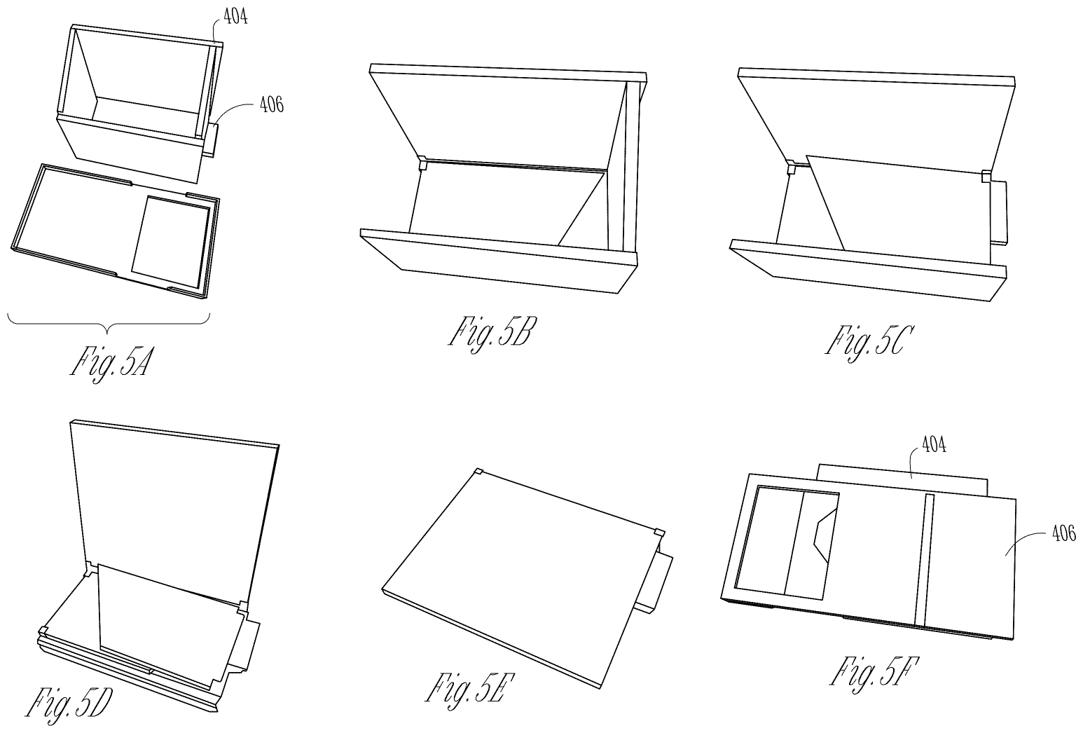

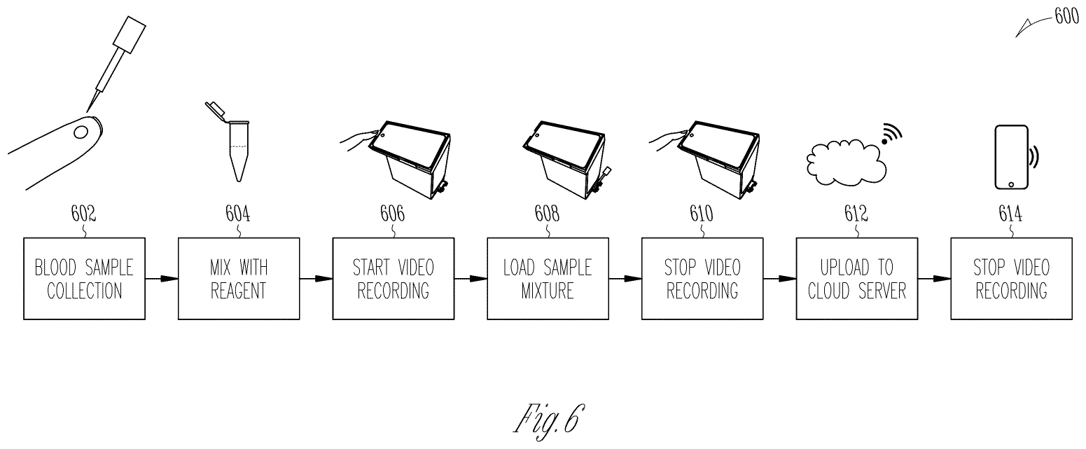

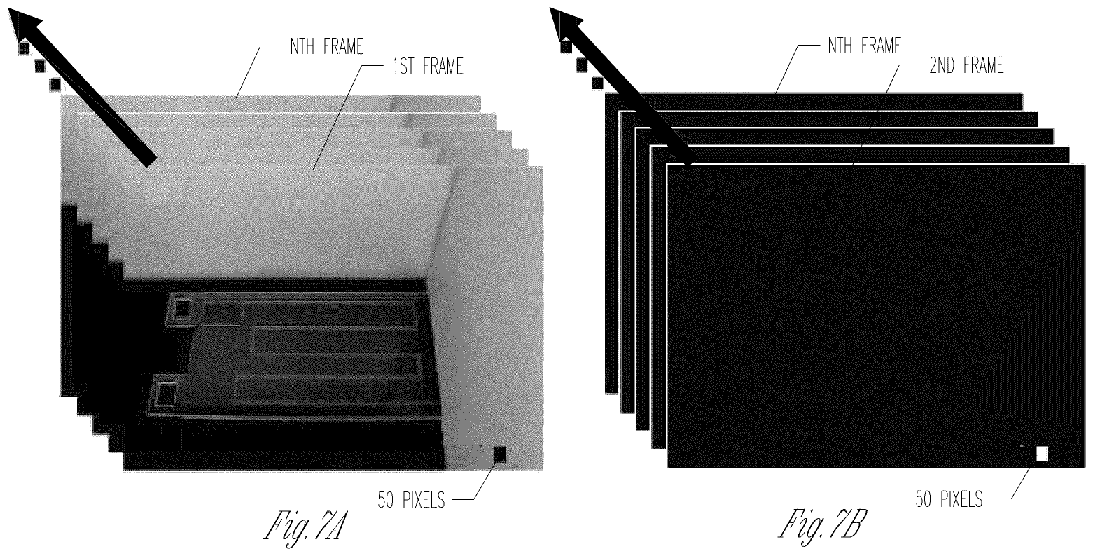

FIGS. 4A and 4B illustrate, in perspective views, an example smartphone-based monitoring device 400 (implementing the device 104 of FIG. 1) according to one embodiment. FIG. 4A shows the platform (or housing) 402 by itself, and FIG. 4B depicts the platform 402 with a smartphone 403 and microfluidic cartridge 102 inserted. The platform 402 may be 3D-printed from a suitable 3D-printable material, such as from a thermoplastic, thermosetting plastic, composite, or metal. For instance, in some embodiments, the platform 402 is printed from PLA filament, which is beneficial due to its ease of printing and low cost. Alternatively, the platform 402 can also be made from paper or cardboard. The platform 402 may include two parts: a bottom part 404 shaped like an open box with a base and side walls, and a removable top part or “lid” serving as a smartphone holder 406. This smartphone holder can be customized for different types of smartphones, e.g., having different sizes or camera locations. In some embodiments, the bottom part 404 itself is constructed from separately 3D-printed base and wall components, which may be connected, e.g., by metal rods. The connects between the base and the four walls may be hinged connections, allowing the bottom part 404 to be folded, as illustrated in FIGS. 5A-5F.

The smartphone holder (or lid) 406 has an opening 408 (shown in FIG. 4A), positioned such that, when the smartphone 403 is placed in the holder 406 with its screen facing up, the smartphone rear camera 409 (indicated in phantom line because of its location on the rear surface of the smartphone 403) faces down (at an angle) and can thus view the interior of the platform 402, including, in particular, the base. The platform 402 includes a dock or loading zone 410 at the bottom that is used for loading the microfluidic cartridge 102 into the base, and the base may define a tray configured to receive and fix the location of the inserted cartridge 102. The bottom part 404 provides a uniform environment for video recording, and is equipped with one or more LED backlight modules, which may be powered by the smartphone itself, eliminating the need for an external power source. The LED backlight module(s) are mounted inside the box (and thus not visible from the outside) on a side wall, configured to provide uniform illumination across the entire microchannel. In one example, two white LED backlight modules (e.g., Adafruit modules 1626 and 1622) are assembled on the interior surface of the front-facing side wall 412. The other sidewalls may be white to help illuminate the microchannel by diffusely reflecting light received from the backlight modules. The base may be black to improve the relative signal strength received from the illuminated microchannel.

As can be seen, the platform 402 has a unique tilted design, with the smartphone holder 406 oriented at a non-zero tilt angle (e.g., a 30° angle) relative to the bottom tray such that the plane of the smartphone placed into the holder 406 encloses the same (e.g.,) 30° angle with respect to the plane of the cartridge 102. This tilted configuration allows the flow of the sample, even for a transparent sample, to be easily visualized based on a total internal reflection signal. When the channel is not filled with any solution, it contains air with a refractive index that is much smaller than that of the top plastic (e.g., PET) layer of the cartridge, leading to reflection of the illumination light at the boundary between the plastic layer and the empty channel. However, when the channel is filled with sample solution, the difference in refractive index between the plastic layer and the channel decreases, leading to an increase in the critical angle of total internal reflection and a reduction in the intensity of the reflected light. By tilting the smartphone and with it the plane of the camera, the reflected light from the boundary between the plastic layer and the channel can be captured. The difference in the intensity of the reflected light indicates the filled or empty status of the channel, thus enabling the detection of the presence of a solution. In general, determining the optimal tilt angle involves a tradeoff between the strength of the signal due to total internal reflection and the view of the microchannel. While the signal strength increases with greater tilt angles, the cartridge takes up a larger portion of the field of view at smaller angles. In various embodiments, a suitable tradeoff can be achieved with tilt angles between the plane of the lid or smartphone and the plane of the cartridge in the range from 20° to 40°, or preferably in the range from 25° to 35°.

While the monitoring device 400 has been described specifically as a smartphone-based device, it will be readily understood by those of ordinary skill in the art that other smartphone-like devices, such as tablets or phablets (i.e., devices with form factors somewhere between those of smartphones and tablets) may be used in place of the smartphone, with suitable adjustments, e.g., in size and the location of the opening, to the lid, or smartphone holder, 406. A smartphone-like device is herein generally understood as an electronic device having a tablet shape, equipped with a camera and also providing computational functionality and/or a network connection for communicating with other devices. Taking advantage of the ubiquity of smartphones and other smartphone-like devices, blood coagulation systems can be made accessible at low cost by simply providing a kit including the microfluidic cartridge and the platform with lighting module, for use in conjunction with the smartphone-like devices. Kits can be provided with different types of lids to accommodate different smartphone-like devices. Each kit can come with a single selectable lid, or with multiple lids to provide flexibility for pairing the platform with multiple different smartphone-like devices.

In various embodiments, the platform 402 (optionally including the lighting module) is designed to be foldable, which increases its portability and durability, with minimal (e.g., less than 10%) increase in the weight and cost of the platform 402. Beneficially, when the platform 402 folded, its reduced volume makes it easy to store and transport.

FIGS. 5A-5F are perspective views illustrating an example workflow for folding the 3D-printed platform of FIGS. 4A and 4B, according to one embodiment. First, the lid 406 is removed from the bottom part of the platform (FIG. 5A). Then, the four side walls are sequentially folded in onto the base (FIGS. 5B-5E). Finally, the folded platform can be flipped an covered with the platform holder.

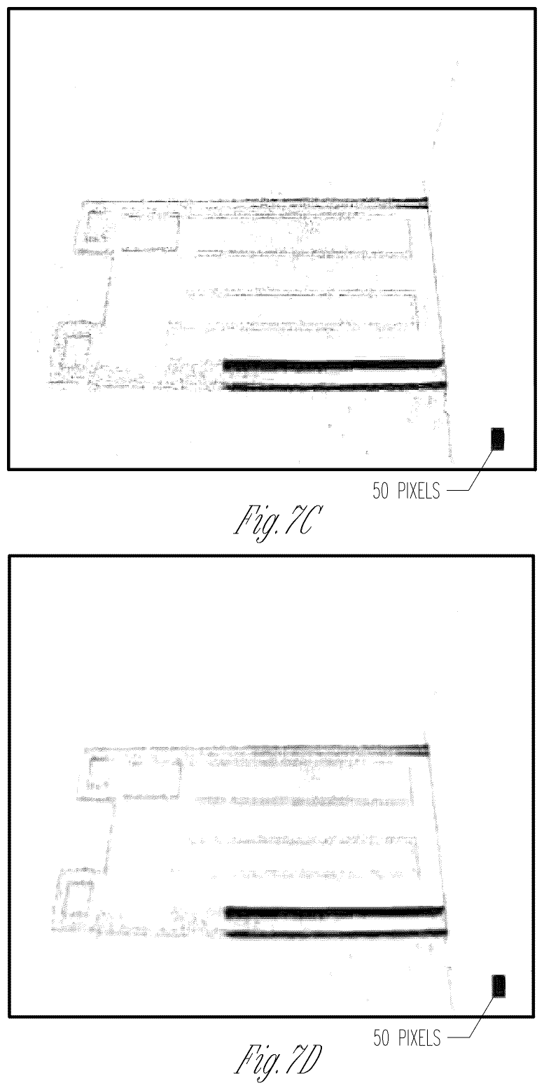

FIG. 6 is a flowchart of an example workflow 600 for measuring blood coagulation, in accordance with various embodiments. The workflow 600 begins (at 602) with taking a blood sample, e.g., using a finger prick. Unless the blood sample is measured immediately, it is mixed with a coagulation agent and stored for later use. Just prior to measurement (at 604), an anticoagulation reagent (or anticoagulant) is added to the mixture to initiate the coagulation process. Then, video recording is started (at 606), and the sample mixture is loaded into the cartridge (at 608), where it begins to flow through the microchannel. After the sample flow has stopped, the video recording is likewise stopped (at 610). Video recording may be started and stopped manually, e.g., in embodiments using a smartphone camera for video acquisition, on the touchscreen of the smartphone. The length of the video may be on the order of a couple of minutes. The recorded video may be uploaded to a remote server (at 612) for processing and analysis (at 614). Alternatively, the processing may be performed locally, e.g. on the same smartphone as used to acquire the video. Finally, the results of the analysis, such as the measured flow stopping time or a PT/INR value derived therefrom, may be presented to the user (e.g., on the smartphone screen).

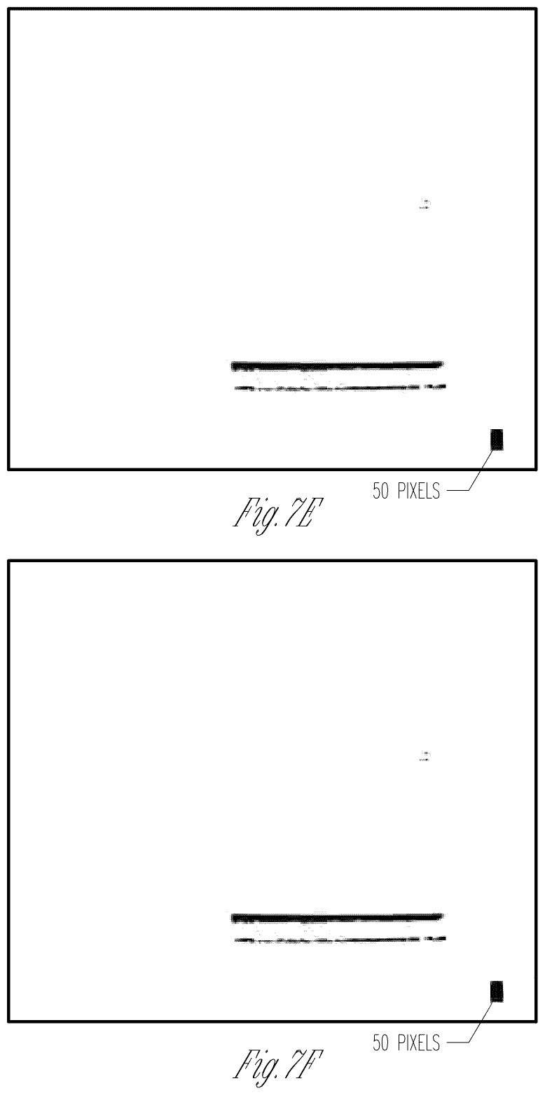

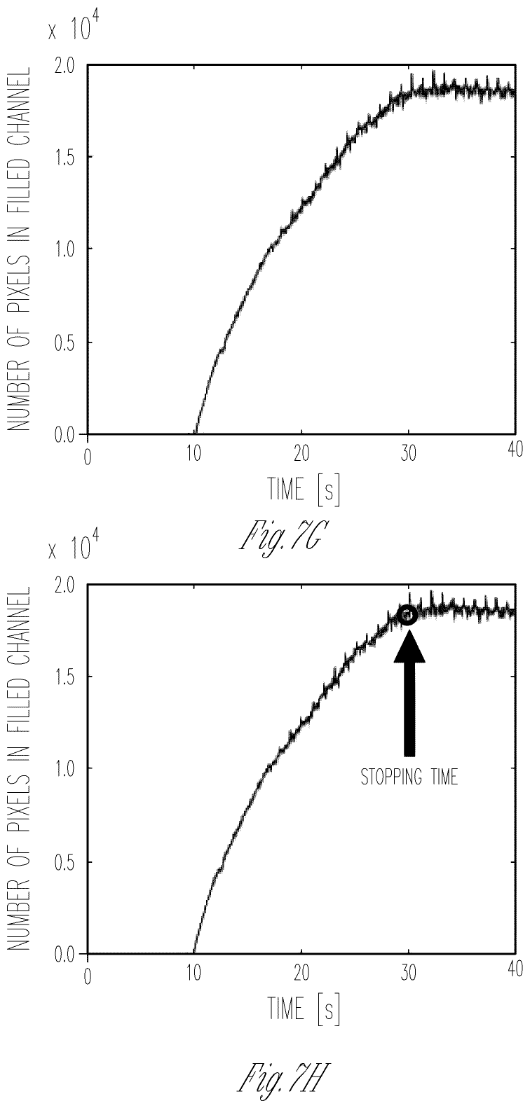

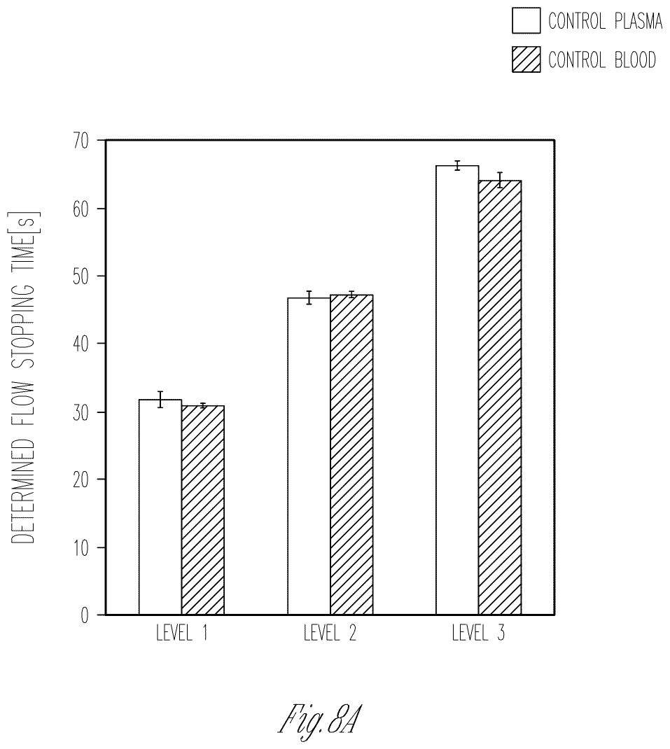

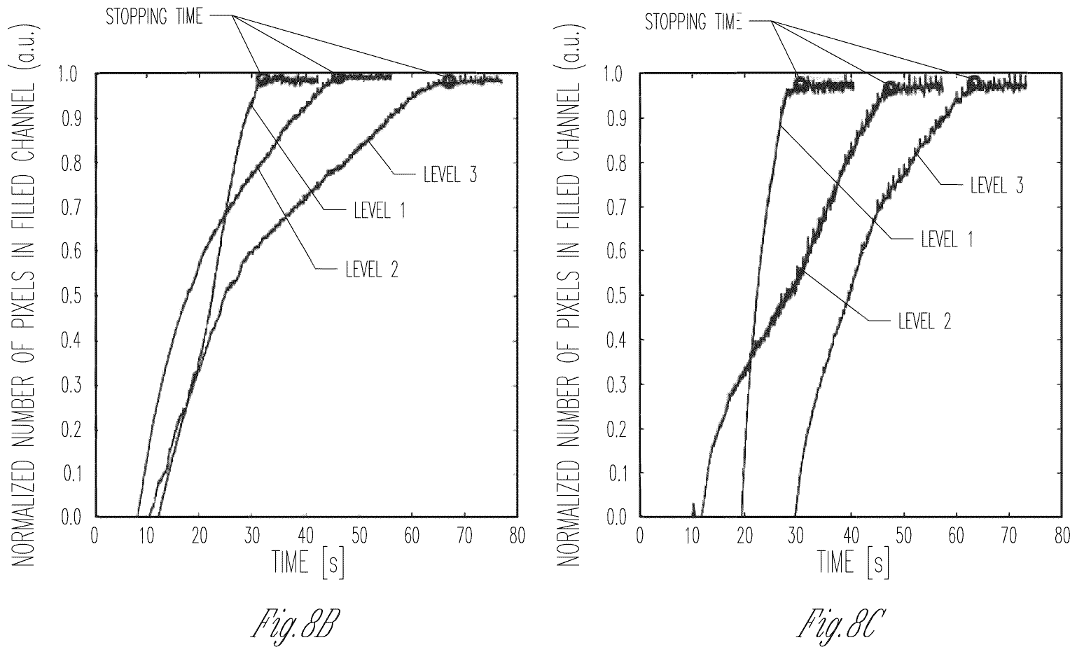

FIGS. 7A-7H illustrate the workflow of an example video processing algorithm to determine the flow stopping time of a blood sample, in accordance with one embodiment. To ensure that the same algorithm can be used for both plasma samples (which appear transparent) and whole-blood samples (which appear red), video may initially be recorded in three color channels: red, green, and blue (RGB). However, the RGB frames may then be converted to grayscale frames, shown in FIG. 7A, to avoid the variation caused by the intensity difference in different channels. At a high level, to estimate when the sample flow in the channel stops or when the flow rate drops dramatically, the algorithm first identifies the pixels corresponding to the filled channel portion in a given frame, and then compares the pixel count for the filled channel portion in the current frame with the pixel counts for the filled channel portion in a previous frame corresponding to a specified earlier time. The frames are processed sequentially, beginning with the earliest recorded frame, until the stop of the flow has been detected.

In more detail, to identify the pixels that correspond to the filled channel in a given frame, the color or grayscale values of the pixels in that frame are compared to those in the first frame, e.g., by subtracting the frame from the first frame (which was presumably acquired before sample enters the microchannel), as shown in FIG. 7B. The frame resulting from the subtraction includes the pixels of the filled channel portion, as well as noise. Noise is reduced, in one example, by first applying a threshold with a low value, e.g., 5 (as shown in FIG. 7C), then applying a 9×9 average filter to reduce the random noise values that may have similar values to the valid data points (as shown in FIG. 7D), and finally, applying a second threshold with a higher value, e.g., 50, to remove any remaining noise and then set the background to 255 (as shown in FIG. 7E).

Once the pixels corresponding to the filled channel portion have been identified in a given frame, the frame is cropped, e.g., based on the cartridge size to remove noise from the sharp edges of the cartridge, and the area of the filled channel portion of the frame (e.g., as shown in FIG. 7F) is estimated by counting the number of pixels with a value of less than 255. An example result is illustrated in FIG. 7G, showing a graph of the number of pixels in the filled channel portion (herein also referred to as “pixel count”) as a function of time (measured in s), where time can be computed from the frame number within the video, multiplied by the frame rate. To distinguish between stationary and flowing conditions, the number of pixels in the filled channel portion at the current frame is compared with the number of pixels in the filled channel portion at a specified earlier frame, that is, a frame that precedes the current frame by a specified time interval, e.g., ten seconds. The specified time interval is chosen to be long enough to filter out small fluctuations due to random noise and short enough to detect changes in filled channel patterns. Further, this comparison with a specified earlier frame may be performed for the last two frames to reduce the risk of erroneous results caused by sudden changes in lighting or other transient effects. If the number of pixels in the filled channel portion at the current frame is not greater than the number of pixels in the filled channel portion at the specified earlier frame (e.g., the frame ten seconds earlier), then the algorithm stops and records the flow stopping time, which as indicated in the graph of pixel count vs. time shown in FIG. 7H. Consequently, the algorithm generally need not process all the frames in the video file. Rather, the last frame being processed (corresponding to the n-th frame in FIGS. 7A and 7B), is the frame ten seconds (or some other specified time interval) later than the flow-stopping time.

The flow-stopping time determined from acquired video of sample flowing in a microfluidic channel is in itself a metric of blood coagulation, which can also be related to the conventionally measured prothrombin time, or more specifically the INR, by calibration. The INR is commonly computed as follows:

$$INR = {( \frac{{PT}_{test}}{P {T}_{n o r m a l}} )}^{ISI} ,$$

where PTₜₑₛₜ is the measured prothrombin time, and PTₙₒᵣₘₐₗ is the prothrombin time in the normal range. The international sensitivity index ISI is a standardization parameter used to calibrate different thromboplastin reagents used in the PT test, ensuring accurate and consistent results across different laboratories. The flow-stopping time, STₜₑₛₜ, can be converted to the INR value based on the following formula:

$$INR = {( \frac{S {T}_{test}}{a} )}^{b} . \qquad ( 2 )$$

The values of the normalization factor a and the calibration factor b can both be calibrated based on pairs of the measured flow-stopping time and known INR (e.g., as determined by a standard laboratory PT/INR test) for multiple blood samples by curve fitting.

The above-described algorithm for processing the video of a blood sample flowing in the microchannel and determining the associated flow-stopping time and, if desired, converting it to INR, can generally be implemented in any of many suitable programming languages, including, without limitation, Python, C/C++/C#, Java, and/or MATLAB. The choice of language may depend in part on the type of computing facility utilized to execute the program. For example, MATLAB may be used for local processing (e.g., on a smartphone used to record the video) because it provides a convenient and powerful environment, in which it is easy to improve the algorithm with visualized variables. On the other hand, Python may be more suitable for execution of the program on cloud servers to take advantage of the flexibility, accessibility, and cost-effectiveness of cloud computing.

The program code may be stored in one or more machine-readable media. The term “machine-readable medium” may include any medium that is capable of storing, encoding, or carrying instructions for execution by a computer processor (such as a CPU, GPU, or other hardware processor) of a computing device (such as a personal computer, server computer, smartphone, etc.) to cause the computer processor to perform the described algorithm and associated computational methods, or that is capable of storing, encoding or carrying data structures used by or associated with such instructions. Examples of machine-readable media include solid-state memories and optical and magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media are non-transitory machine readable media, as distinct, e.g., from a transitory propagating signal.

Having described systems, devices, and computational methods for fluid-mechanical blood coagulation testing, the following figures illustrate the result of performance evaluations of blood coagulation testing in accordance with one embodiment. The coagulation testing was performed with an example system using a cartridge as depicted in FIGS. 2A-2B and a monitoring device as depicted in FIGS. 4A-4B in conjunction with a Samsung S20 Ultra smartphone to acquire video at a resolution of 1920×1080 and a frame rate of 30 frames per second. The tested samples include control plasma samples and control blood samples at three different coagulation control levels (levels 1, 2, and 3, with higher numbers corresponding to longer prothrombin times), as well as clinical whole blood samples. The control plasma samples are Pacific Hemostasis™ Coagulation Controls obtained from Thermo Scientific. The control blood samples were prepared from human blood from a health participant with an INR of 0.9 by centrifugation and removal of the supernatant layer and replacement with control plasma of different levels. To conduct the tests, coagulation reagent solution prepared from a coagulation reagent (Pacific Hemostasis™ Prothrombin Time (PT) reagent, thromboplastin-D, obtained from Thermo Scientific) was mixed with the sample, video recording was initiated, and the mixed sample was then introduced into the cartridge from the loading zone. Video recording was stopped at least 10 seconds after the sample flow stop was observed in the channel.

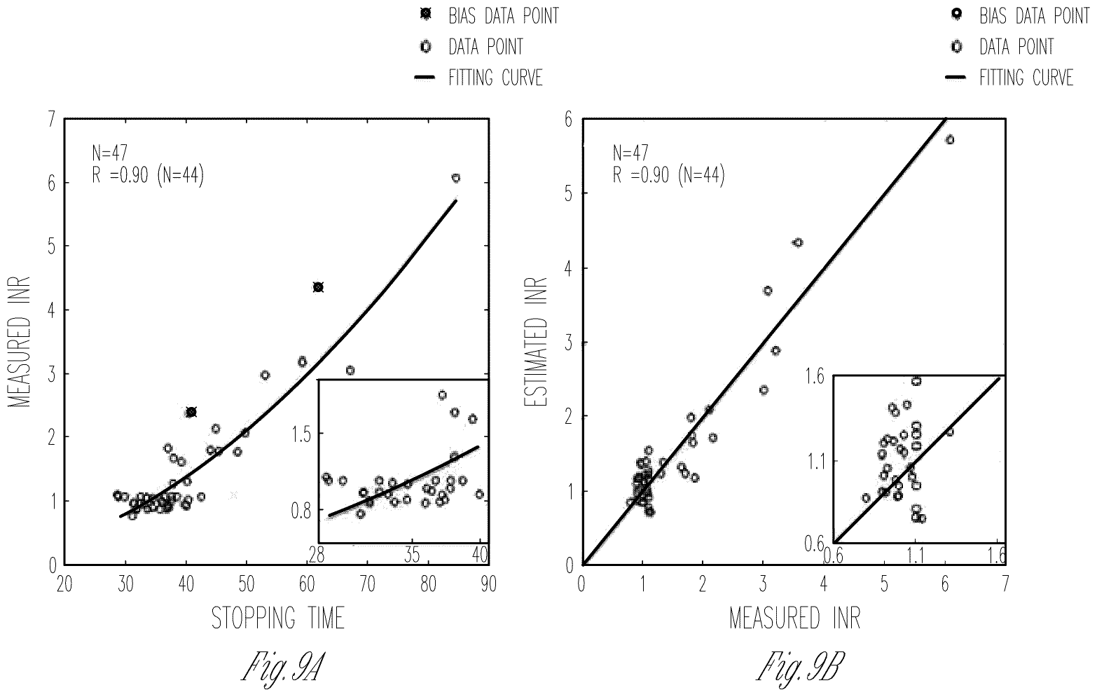

FIGS. 8A-8C illustrate flow stopping time measurements of control plasma samples and control blood samples at three different coagulation control levels. FIG. 8A shows, for each of the samples, the average flow stopping time computed from three measurements, along with the standard deviation error bar. As can be seen, the average flow stopping time of level 1 control plasma samples was 31.78 s with a standard deviation of 1.18, while the average flow stopping time of level 1 control blood samples was slightly shorter, at 30.91 s with a standard deviation of 0.32. Notably, level 2 and level 3 control plasma and control blood samples were abnormal, and the device successfully identified these samples as having longer stopping times. Specifically, the average flow stopping time of level 2 control plasma samples was 46.78 s with a standard deviation of 0.94, while the average flow stopping time of level 2 control blood samples was 47.27 s with a standard deviation of 0.47. For the level 3 samples, the average flow-stopping time further increased, as expected. The average flow stopping time of level 3 control plasma samples was 66.27 s with a standard deviation of 0.67, and the average flow stopping time of level 3 control blood samples was 64.11 s with a standard deviation of 1.10. These results suggest that the device has the ability to detect abnormal blood coagulation patterns accurately.

FIGS. 8B and 8C show the normalized number of pixels in the filled channel portion as a function of time for control plasma samples and control blood samples, respectively. Pixel numbers for each sample were normalized by taking the ratio of measured value to the maximum value for the sample to allow for comparability between samples despite different flow rates and travel distances in the channels. As can be seen, the control blood sample data (FIG. 8C) generally fluctuated more than the control plasma sample data (FIG. 8B), especially when the samples stopped in the channel. This is due to the red color of the control blood samples, which introduced a larger color difference between the filled and empty channels, such that random noise caused by the slight change in the captured light intensity lead to changes in the computed channel pattern during the processing step of smoothing due to color leakage. However, the impact of the data fluctuation was negligible when the time gap between the current number of pixels in the filled channel and the previous number of pixels in the filled channel increased to 10 s, because the changes in the computed channel pattern caused by the noise were random and rapid.

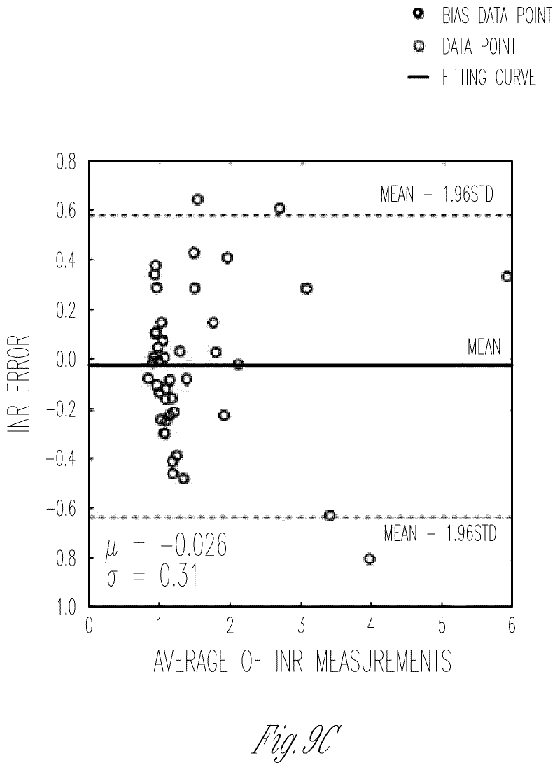

FIGS. 9A-9C illustrate performance evaluations of INR estimation in accordance with one embodiment based on 47 human whole blood samples with known INR values. The INR values of the blood samples were measured using a benchtop hemostasis analyzer (ACL TOP 750, Werfen). FIG. 9A shows the measured INR plotted vs. the measured flow-stopping time, along with a fitted curve. Three data points with INR values of 1.10, 2.40, and 4.35 (highlighted in FIG. 9A) were identified as biased because the sample flow had stagnated before reaching the final stopping points, and were therefore excluded from further analysis. Curve-fitting on the remaining 44 data points, using the above equation for INR computed from STₜₑₛₜ, resulted in a normalization factor a of 33.85 and a calibration factor b of 1.875, with an R-square value of 0.9. FIG. 9B is a plot directly comparing the INR values estimated from the measured flow-stopping times against the respective measured INR values. Linear curve fitting on both the estimated INR and measured INR resulted in an R-square value of 0.9. FIG. 9C is a Bland-Altman plot of the data, which shows good agreement between the estimated INR values and the measured INR values, with a mean difference between them of only −0.026. These results demonstrate the effectiveness and reliability of the disclosed approach to estimating INR values.

Presented herein is a novel, fluid-mechanical approach to screening INR levels from whole blood that can be implemented with cost-effective, lightweight, and portable hardware, making it highly accessible and suitable for point-of-care and self-testing. The approach involves the flow of a blood sample through a microchannel, where a blood clot forms, causing the flow to naturally stop. This process is recorded in a video, and a customized video processing algorithm is employed to determine the flow-stopping time directly proportional to the blood clotting time. In various embodiments, the video is acquired by a smartphone (or similar electronic device), which may also be used for video processing. The remaining system components for measuring flow-stopping time, which include a microfluidic cartridge, lighting module for illumination, and (e.g., 3D-printed) platform for holding the various other components, can be manufactured at low cost, e.g., in some examples, for less than $8. The platform may be configured to ensure a uniform measurement environment not impacted by external illumination conditions, enabling the use of the device under a wide range of conditions. Further, the platform may be foldable to reduce the total volume of the device, making it highly portable. The platform can be modified to fit different types of smartphones by editing the smartphone holder, which makes the device highly customizable and allows users to use their preferred smartphones. By combining portability, cost-effectiveness, accuracy, and flexibility, the disclosed devices have the potential to greatly improve the accessibility and convenience of blood coagulation testing.

What is claimed is:

1. A method for blood coagulation testing, the method comprising:
loading a blood sample into a microfluidic cartridge to cause the blood sample to flow in a microchannel of the cartridge;
illuminating the microchannel;
recording a video of the microchannel as the blood sample flows in the microchannel; and
processing at least a portion of the video frame by frame to:
identify, in each processed frame, a portion of the microchannel that is filled with the blood sample, and
determine a flow-stopping time based on comparisons, between the processed frames, of the identified filled portions of the microchannel.

2. The method of claim 1, wherein the video comprises signal resulting from total internal reflection of illumination light at a boundary of the microchannel, and wherein the portion of the microchannel that is filled with the blood sample is identified based on the signal.

3. The method of claim 1, further comprising stopping recording after flow of the blood sample in the microchannel stops.

4. The method of claim 1, wherein the processing further comprises counting, for each processed frame, a number of pixels in the identified filled portion of the microchannel, wherein the comparisons between the processed frames comprise comparing the number of pixels in the identified filled portion of the microchannel for a current frame with the number of pixels in the identified filled portion of the microchannel for a specified earlier frame, and wherein, when the number of pixels for the current frame does not exceed the number of pixels for the specified earlier frame, the flow-stopping time is determined based on the specified earlier frame.

5. The method of claim 1, wherein the video is recorded with an integrated camera of a smartphone-like device.

6. A system for measuring blood coagulation, the system comprising a kit for use in conjunction with a smartphone-like device comprising an integrated camera, the kit comprising:
a microfluidic cartridge defining a microchannel to be loaded with a blood sample;
a lighting module; and
a platform configured to hold the lighting module and the smartphone-like device in fixed spatial relation to the microfluidic cartridge so as to position and orient the lighting module to illuminate the microchannel and the integrated camera to acquire a video of the blood sample flowing in the microchannel until flow stops due to coagulation.

7. The system of claim 6, further comprising the smartphone-like device.

8. The system of claim 6, further comprising a computational facility for processing the video to determine a flow-stopping time.

9. The system of claim 6, wherein the cartridge is a laminated structured comprising a transparent plastic layer and a glass layer adhered to each other by an adhesive tape defining the microchannel.

10. The system of claim 6, wherein the platform is 3D-printed.

11. The system of claim 6, wherein the platform is configured to hold the smartphone-like device at an angle between 25 and 35 degrees relative to the microfluidic cartridge.

12. The system of claim 6, wherein the platform is foldable.

13. The system of claim 6, wherein the platform comprises an open box defining a bottom tray and side walls, and a lid oriented at an angle relative to the bottom tray and configured to hold the smartphone-like device, wherein the bottom tray is configured to hold the microfluidic cartridge, and wherein the lighting module is installed on an interior surface of one of the side walls.

14. The system of claim 13, wherein the lid is removable and the side walls are foldable to flatten the open box.

15. The system of claim 13, wherein the bottom tray defines a dock for loading the microfluidic cartridge.

16. The system of claim 6, wherein the lighting module comprises one or more light-emitting-diode (LED) backlight modules.

17. The system of claim 6, wherein the lighting module is configured to be powered by the smartphone-like device.

18. A machine-readable medium storing instructions for processing a video of a blood sample flowing in a microchannel until flow stops due to coagulation, the instructions, when executed by a computer processor, causing the computer processor to perform operations comprising:
successively processing video frames of at least a portion of the video, wherein processing each video frame comprises:
determining a number of pixels corresponding to a sample-filled portion of the microchannel, and
comparing the determined number of pixels with a number of pixels in a sample- filled portion of the microchannel determined from a previous video frame; and
based on the processed video frames, determining a flow-stopping time associated with a video frame beyond which the determined number of pixels does not increase.

19. The machine-readable medium of claim 18, wherein the previous video frame precedes the video frame by a specified number of video frames, and wherein processing of the video frames stops at a video frame whose associated determined number of pixels is no greater than the number of pixels determined from the previous video frame.

20. The machine-readable medium of claim 18, wherein the operations further comprise computing, from the flow-stopping time, an International Normalized Ratio (INR) value of the blood sample.
